(19) United States
(12) Patent Application Publication
(10) Pub. No.: US 2015/0142494 A1
(43) Pub. Date: May 21, 2015

(54) SYSTEM AND METHOD FOR SCHEDULING TEMPORARY RESOURCES

(71) Applicant: Descisys Ltd., Auckland (NZ)

(72) Inventors: Kent Zein Kien YAP, Auckland (NZ); Philip Martin JORDAN, Auckland (NZ); Vilosh Marion BRITO, Surrey (GB)

(21) Appl. No.: 14/549,802

(22) Filed: Nov. 21, 2014

Related U.S. Application Data
(60) Provisional application No. 61/907,279, filed on Nov. 21, 2013.
(60) Provisional application No. 62/034,891, filed on Aug. 8, 2014.

(51) Int. Cl. G06Q 10/06; G06Q 10/10; G06Q 10/04

(52) U.S. Cl. CPC G06Q 10/06314; G06Q 10/04; G06Q 10/1093
USPC 705/7.18; 705/7.24

(57) ABSTRACT

Computer-aided systems and methods of scheduling resources, such as human resources and temporary human resources in particular, including steps of forecasting a required revenue for an operation in at least one desired time slot, reviewing historical revenue data of said operation or a similar operation, analysing said required revenue and said historical revenue and determining a work effort metric for said at least one desired time slot to meet said required revenue, generated or selecting a template for said at least one desired time slot showing the desired said work effort metric, and filling said template by allocating specific resources to said at least one desired time slot.

### CROSS-REFERENCE TO RELATED APPLICATIONS

This application is claims the benefit of U.S. Provisional Application No. 61/907,279, filed on Nov. 21, 2013, and 62/034,891, filed on Aug. 8, 2014, the contents of both of which are incorporated herein by reference in their entirety.

### TECHNICAL FIELD OF THE INVENTION

Embodiments of the present invention relate to scheduling of human resources. In particular, though not solely, embodiments of the present invention are directed to allow a user to schedule human resources where those resources are temporary, for example shift workers.

### BACKGROUND OF THE INVENTION

Scheduling human resources to perform a task or shifts is difficult. This is because there are factors beyond the control of the manager that may prevent a person performing their shift. This is in addition to any factors such as requirements around how many hours a person may work, or how many shifts back to back they can do and the demand for products and services in industries where stock cannot be used to smoothen peaks and troughs in demand. Other factors may include the requirements for contiguous hours of work, reliability, temporary absence, desired work hours, fast moving nature of the business, wide variability in skills, and preserving or increasing margins and competitiveness etc.

A further complication to this scheduling is when the resources are temporary ones, for example shift workers where the work patterns are irregular.

This is because at any one time the human resources pool that is available is shifting and may not be available, or may have changed from one shift to the next. Also the skill levels within that pool may be highly variable.

Examples of places of work that may require, or find use for, embodiments of the present invention are ones that have one or more of the following properties: (a) require worker with skills to work on hour by hour basis; (b) require a certain number of staff of a certain skill per each hour (work effort forecast); (c) require enough staff of a given skill to fulfil work effort metric; (d) require that staff counts are minimized; (e) staff have hard skills and soft skills, e.g., driver (hard skill) can run the make line (soft skill); (f) staff have other soft requirements, e.g., “want's to work more hours”, “is unreliable”, not available due to exams”, etc.; and (g) staff have requirement for contiguous hours of work.

Solutions that have been used to date for such scheduling of temporary resources are relatively unsophisticated and may use a spread sheet or Gantt chart style approach. These have at least the disadvantage of being cumbersome to operate and needing manual entering of the staff name. Further, they are not sufficiently agile and easy to adapt to the changing nature of scheduling such temporary resources. A user in, for instance, a pizza store, may have to consider the required skills, the forecast requirements, the available staff, the staff skills and overall constraints when creating a schedule. This often results in a user having to create a schedule by trial and error by adding and amending staff shifts until a suitable schedule has been created.

This has the disadvantage of taking considerable time and will likely not take into account all relevant information. In particular in fast moving industries margins can be very thin due to competition and therefore a tool that provides accurate scheduling can provide an advantage and help keep costs down, reduce errors and improve margins and competitiveness. Further the dynamics of staff and the weekly, daily or hourly workload may mean rapid accurate scheduling is needed, which when done by traditional means will not meet the time frame required, or accuracy desired. Such traditional means also may not give staff sufficient warning due to the additional time they take. Such traditional means does not easily allow variation in the constraints or schedule after completion of the schedule.

In this specification, where reference has been made to patent specifications, other external documents, or other sources of information, this is generally for the purpose of providing a context for discussing the features of the invention. Unless specifically stated otherwise, reference to such external documents is not to be construed as an admission that such documents, or such sources of information, in any jurisdiction, are prior art, or form part of the common general knowledge in the art.

It is therefore an object of the present invention to provide an improved scheduling method for scheduling temporary resources, or to overcome one or more of the above shortcomings, or address the above desiderata, or to at least provide the public with a useful choice.

### SUMMARY OF EMBODIMENTS OF THE INVENTION

In a first aspect the present invention may be said to broadly consist in a method of scheduling resources, comprising or including the steps of forecasting a required revenue for an operation in at least one desired time slot, reviewing historical revenue data of said operation or a similar operation, analysing said required revenue and said historical revenue and determining a work effort metric for said at least one desired time slot to meet said required revenue, generated or selecting a template for said at least one desired time slot showing the desired said work effort metric, and filling said template by allocating specific resources to said at least one desired time slot.

In some embodiments the template is filed by a user.

In some embodiments the specific resources are allocated to allow said operation to meet said revenue targets.

In some embodiments, said resources are temporary, for example, human workers, and therefore have to be scheduled on a regular basis but with irregular work patterns.

In some embodiments, said template is generated as part of said method, or said template is a pre-existing one.

In some embodiments, said work effort metric is based on a standard period of time, for example per minute, hour or day.

In some embodiments, said work effort metric includes one or a number of resources and the skill required for that said at least one time slot.

In some embodiments, said analysis includes at least a statistical analysis of said required revenue and or said historical revenue.

In some embodiments, said at least one time slot arranged to fill a standard time period, for example a working shift, working day or 24-hour period.

In some alternate embodiments, said at least one time slot is of variable length to cover any period of time or time increments as needed.

In some embodiments, there are a plurality of said time slots.

In some embodiments, there are a plurality of said at least one time slot to fill said standard time period.

In some embodiments, said revenue data is based on any one or more of the following by said operation: units made; units sold; delivery mechanism; and effort necessary.

In some embodiments, said resources are human resources.

In some embodiments, said revenue data is based on units per time increment, for example, but not limited to, pizzas, hamburgers, or products per hour.

In some embodiments, said analysis includes units delivered per time increment.

In some embodiments, said template is generated as part of a user interface which a user can then drag and drop said resources to fill said template.

In some embodiments, said template includes multiple operations, or operation stations within said at least one time slot.

In some embodiments, said user can vary allocation of said resources to obtain a desired cost to revenue ratio.

In some embodiments, said method is performed at least in part on a computer, or computer based system.

In some embodiments, said method comprises the step of comparing the forecast said required revenue with actual revenue data achieved by the operation.

In some embodiments, said comparing uses statistical analysis.

In some embodiments, said method comprises the step of updating the predicted revenue data with said actual revenue data.

In some embodiments, said method includes the step of comparing the forecast of said required revenue or the predicted revenue data with the actual revenue data.

In some embodiments, said method includes the step of modifying the template or parameters to cause the predicted revenue data to match or resemble the actual revenue data.

In some embodiments, said method comprises the step of creating an amended template based on actual revenue data.

In some embodiments, said method comprises the step of creating a plurality of template options or an amended template based on actual revenue data and the step selecting one of the said plurality of template options or said amended template.

In some embodiments, said method comprises selecting one of the plurality of template options.

In some embodiments, said plurality of templates include alternate distributions of time slots or resource requirements.

In some embodiments, said method comprises the step of reviewing the performance of said specific resources.

In some embodiments, said method comprises the step of comparing the performance of said specific resource with the expected performance of said specific resource.

In some embodiments, said method comprises the step of adjusting the analyses to include the actual performance of said specific resource.

In some embodiments, said method comprises the step of presenting the performance of one or a plurality of said specific resources for review.

In some embodiments, said analysing could include adjusting the work effort metric based on actual revenue data.

In some embodiments, said analysing could include adjusting the performance of one or a plurality of said specific resources based on time of day or resource schedule.

In some embodiments, said method includes the step of calculating staff performance relative to expected performance.

In some embodiments, said method includes the step of identifying staff performing above or below expected performance.

In some embodiments, said method includes the step of calculating a performance of the system and reporting the performance of the system to a user.

In some embodiments, said reporting includes a metric corresponding to a change to the template.

In some embodiments, said reporting uses a smart device or web enabled system, such as but not limited to SMS, email, a popup dialog on a website or an instant message on a smart device or otherwise.

In some embodiments, said reporting occurs when a suggested change is proposed to the template.

In some embodiments, said reporting includes an explanation for the change.

In some embodiments, said analysis includes metrics which may be modified by a user of the system.

In some embodiments, said metrics cause the template to alter to adjust to changes in operation.

In some embodiments, the metrics allow said work effort metric to match that required by the scheduled resources.

In some embodiments, said method includes the step of adjusting the template.

In some embodiments, the adjustment of the template is limited within a variance from the generated template.

In another aspect, embodiments of the present invention may be said to broadly comprise a computer implemented method of scheduling resources, where those resources are temporary, comprising or including the steps of, forecasting a required revenue for an operation in at least one desired time slot, reviewing historical revenue data of said operation or a similar operation, analysing said required revenue and said historical revenue and determining a work effort metric for said at least one desired time slot to meet said required revenue, and filling a template for said at least one desired time slot by a user allocating specific resources to said at least one desired time slot to then allow said operation to meet said required revenue.

In yet another aspect, embodiments of the present invention may be said to broadly comprise a computer operated program adapted to run on a computer device to perform a method of scheduling resources, where those resources are temporary, comprising or including the steps of, forecasting a required revenue for an operation in at least one desired time slot, reviewing historical revenue data of said operation or a similar operation, analysing said required revenue and said historical revenue and determining a work effort metric for said at least one desired time slot to meet said required revenue, and filling a template for said at least one desired time slot by a user allocating specific resources to said at least one desired time slot to then allow said operation to meet said required revenue.

In yet a further aspect, embodiments of the present invention may be said to broadly comprise a system for implementing a method of scheduling resources, where those resources are temporary, comprising a processor configured to forecast a required revenue for an operation in at least one desired time slot, review historical revenue data of said operation or a similar operation, analyse said required revenue and said historical revenue and determining a work effort metric for said at least one desired time slot to meet said required revenue, generate or select a template for said at least one desired time slot showing the desired said work effort metric, and file said template by allocating specific resources to said at least one desired time slot.

In a further aspect the present invention consists in a non-transitory storage medium having machine-readable instructions stored thereon, that when executed by a processor cause the processor to perform the method comprising: forecasting a required revenue for an operation in at least one desired time slot; reviewing historical revenue data of said operation or a similar operation; analyzing said required revenue and said historical revenue and determining a work effort metric for said at least one desired time slot to meet said required revenue; generating or selecting a template for said at least one desired time slot showing the desired said work effort metric; and filling said template by allocating specific resources to said at least one desired time slot.

In a further aspect, embodiments of the present invention may be said to broadly comprise a computerised apparatus in communication with a database and operable to perform the method as herein described with reference to any one or more of the accompanying drawings.

In yet another aspect, embodiments of the present invention may be said to broadly comprise a computer program or a computer readable medium containing instructions to cause a computer to perform the method as herein described with reference to any one or more of the accompanying drawings.

In another aspect, embodiments of the present invention may be said to broadly comprise a method of scheduling resources as described herein with reference to any one or more of the accompanying drawings.

In another aspect, embodiments of the present invention comprise a computer implemented method of scheduling resources as described herein with reference to any one or more of the accompanying drawings.

In another aspect, embodiments of the present invention comprise a computer operated program as described herein with reference to any one or more of the accompanying drawings.

In another aspect, embodiments of the present invention comprise a system for implementing a method of scheduling resources as described herein with reference to any one or more of the accompanying drawings.

As used herein the term “and/or” means “and” or “or”, or both.

As used herein “(s)” following a noun means the plural and/or singular forms of the noun.

The term “comprising” as used in this specification means “consisting at least in part of”. When interpreting statements in this specification which include that term, the features, prefaced by that term in each statement, all need to be present, but other features can also be present. Related terms such as “comprise” and “comprised” are to be interpreted in the same manner.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7).

The entire disclosures of all applications, patents and publications, cited above and below, if any, are hereby incorporated by reference.

This invention may also be said broadly to comprise the parts, elements and features referred to or indicated in the specification of the application, individually or collectively, and any or all combinations of any two or more of said parts, elements and features, and where specific integers are mentioned herein which have known equivalents in the art to which this invention relates, such known equivalents are deemed to be incorporated herein as if individually set forth.

Other aspects of the invention may become apparent from the following description which is given by way of example only and with reference to the accompanying drawings.

### BRIEF DESCRIPTION OF THE DRAWINGS

The subject matter regarded as the invention is particularly pointed out and distinctly claimed in the concluding portion of the specification. Embodiments of the invention, however, both as to organization and method of operation, together with objects, features, and advantages thereof, may best be more fully understood by reference to the following detailed description when read with the accompanying drawings in which:

FIG. 1 shows an image of the user interface of the scheduler according to embodiments of the invention, showing the default view when a manager logs into it, with several time slots unpopulated;

FIG. 2 shows a similar view to that of FIG. 1 according to embodiments of the invention, in which the manager or user has populated several time slots, for example with an appropriate worker, with each slot having a required skill;

FIG. 3 shows a flow chart of one embodiment of the invention;

FIGS. 4A, 4B, and 4C show sample update reports according to embodiments of the invention for a series of production units at various times; and

FIG. 5 shows an embodiment of the invention on a computer system.

### DETAILED DESCRIPTION OF EMBODIMENTS OF THE INVENTION

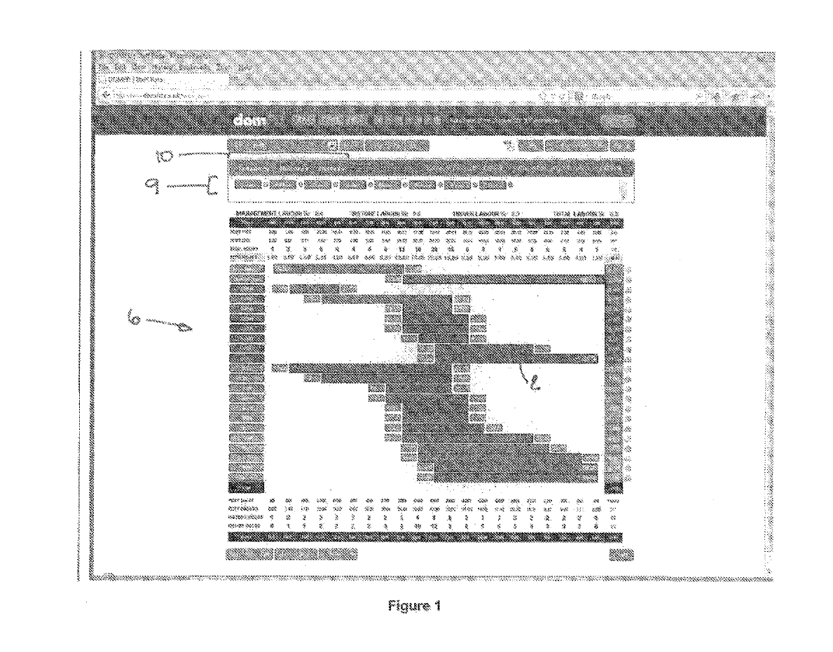

Embodiments of the invention will now be described with reference to FIGS. 1 through 5.

The method allows a user, for example a manager at a store, to manage the store's human resources to best meet the anticipated demand for a given time slot, for example an hour or day, or other variable time as needed based on an analysis of historical trading of that business and other records. The method is particularly useful for shift workers who have differing work patterns and in particular workers whose work schedules are dictated by demand for products and services that are subject to daily peaks and troughs. The system may also be useful for managing casual workers.

The performance of a human resource is important as it can vary over time for a single person, and also from person to person. The actual metric of performance can vary and will depend on the role of that human resource as well as the industry they are in. For example in a fast food business if may be the number of units they can make or deliver per hour.

Embodiments of the invention may work on a time slot basis, so that given a certain expected work on a given day the manager can bring up a carefully distributed set of time slots 2 from a template 6 (or generated by the system automatically) shown in FIG. 1. In this figure the template is generated but the slots 2 have not been filled. This means the manager can quickly allocate their staff 9 into those slots 2, based on the managers understanding of the skills 10 and availability of the staff 9. For example a driver skill may only be able to drive and not operate in the store, or manage, an instore skill may only be able to work instore and not drive, or may be able to drive also, a manager may be able to manage, operate in store and drive. The different skills may be referred to as hard skills, requiring further training or qualifications and soft skills suitable for all or most staff, This allows the user to understand the cost of a level of staffing independently from the actual staff that can be used. Thus, a given template's 6 cost (and therefore the cost as a percentage of revenue) may be understood immediately regardless of staff availability or other distracting operational issues (sickness, reliability of staff, skills required, etc. . . . )

The creation of a template which is dependent on a required work effort metric or required revenue allows a separation between the creation of the template and the selection of the staff. In some cases one of a plurality of prepared templates may be used. The generated template has a plurality of slots or time periods available into which staff may be placed, as required. Each slot may have a set of criteria or constraints, including required skills, or length of shifts. There may also be global constraints to the template such as minimising extra hours or capacity. Therefore the template provides a more efficient method of creating a schedule, as it offers the user or manager a straightforward means to associate staff with each defined time period. This may be completed by a drag and drop type interface or otherwise.

The efficiency of this system is that it separates the scheduling problem into two problems: (1) forming a template based on forecasted and/or historical revenue data (or other data) which provides the required work effort; and (2) placing staff 9 in to each template slot.

This process substantially reduces the complexity of the task when compared to prior art in which the manager would attempt to create a schedule by placing staff in a haphazard manner. The process also ensures that staff requirements can be met by a review of the schedule or inbuilt constraints. These may include requirements for contiguous hours of work, desire to work more or less, reliability, or temporary unavailability. By displaying a blank template before requiring staff to be assigned to it or organised on it the choices available to the manager for possible assignments of each staff member are made clearer. In some embodiments the user or manager may adjust the template to account for local variation or unexpected events.

The method generates a work slots template 6 based on data such as the “unit(s) per hour” and/or “delivery(s) per hour” effort metrics for the day. This could be production units, for example, but not limited to products such as, hamburgers, pizzas, or similar, and the number of units made per time increment, units sold per time increment, the delivery rate and mechanism of those units, and any additional effort needed. By working from these criteria that must be achieved, a manager can then determine what resources 7 are needed to achieve this production metric.

The method may be performed based on forecasted revenue and its relationship to historic information, for example, but not limited to, units per hour and deliveries per hour. This work effort template may be a non-linear relationship and so may require considerable statistical analysis of the source data.

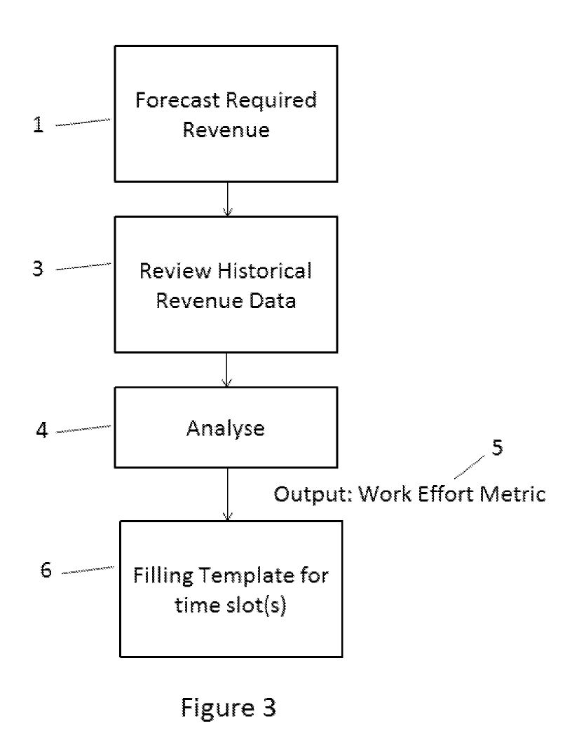

Turning to FIG. 3, the method of scheduling resources first forecasts 1, a required revenue for an operation in at least one desired time slot 2. A review 3 is also made of historical revenue data of the operation or a similar operation. The demand for a given time slot or period of a day can be predicted based on historical data for the same period the year before, or when similar events have happened in the past. An analysis 4 is then made of the required revenue and historical revenue and from this a work effort metric 5 is calculated for the desired time slot 2 to meet that required revenue.

For example, staff efficiency increases when there is a constant flow of work of a similar nature, so during peak times, we see that staff work harder on core operational tasks (for example making units) and take less breaks and defer doing unrelated operational tasks (such as for example, replacing hand cleaner in the wash room). Thus, the analysis of historical worker output per hour needs to also build a function to describe the increasing efficiency of staff as higher outputs are demanded over a portion of the day. For example, a pizza store work might tend to be able to make 12 pizzas per hour on average, but during heavy work time that can peak at 25. This increased output cannot be sustained, so the efficiency function of the day is a complex curve that needs to be modelled.

From the analysis a template 6 for the desired time slot(s) 2 is then filled 11 by a user allocating specific resources to the desired time slot to then allow the operation to meet the required revenue.

In addition to the above, various influences cause each day to have a different product and deliveries capability, for example, traffic causes a drop in deliveries per staff hour at peak travel hours, e.g., at 5:00 p.m. during a weekday, but not at the same time on the weekend. Inventory might be delivered on a Wednesday afternoon, which may cause units produced per staff hour to drop below 10. All of these demand and environmental factors must be gleaned from the history so that an ideal staffing level per hour per day to achieve the forecasted sales and commensurate work output can be scheduled.

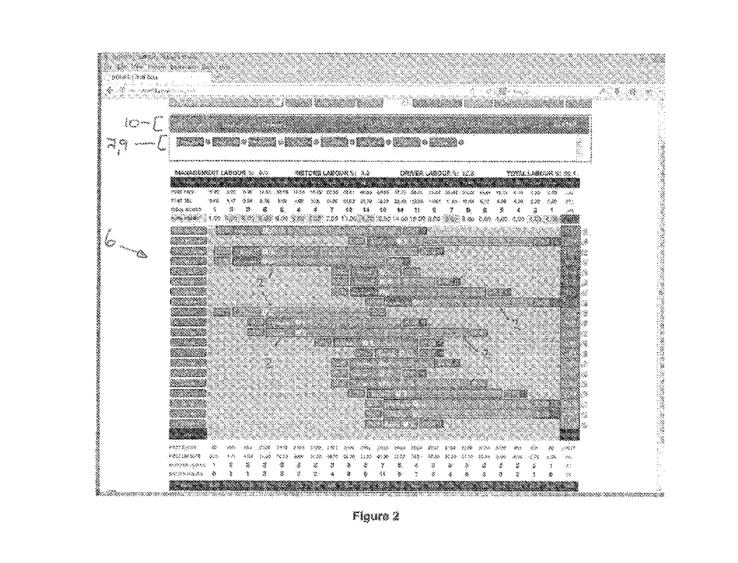

However, a further inventive part of this is to work out an effort metric 5 per hour of the day based on history for each days desired or forecasted revenue to generate a template 6 that fulfils this effort level as shown in FIG. 2 as part of a graphical user interface on a terminal, or computer. Here, for example, it is enabled with a webpage. This puts to one side the issues of staff HR and concentrates on work-hours distribution across the day. The manager is best placed to actually fill the people into the slots 2, and can save staffed templates 6 as well under staffed templates.

In FIG. 2 is shown a day where the manager has filled in the time slots 2 with an appropriate worker 9. Staff 9 or resources 7 can be dragged from the top area down into each slot 2 as desired. Slots 2 can be altered to be longer or shorter and added or removed. Each slot 2 also has a required skill 10 and various staff 9 can fulfil various slots, e.g. managers can do any of the slots including, in store or delivery slots for example.

In an embodiment the system has access to the historical revenue data (and any other historical data) on an on-going basis. This data may be referred to as actuals or updated data and such updates may be carried out on a regular (for example at 15 minute) intervals. This means that when the schedule is implemented the updated data or actuals are then fed back into the system to add to the historical revenue data. For instance, a user may input, and/or data may be fed from a connected or associated system, the generated orders and/or products distribution across a set of time periods (e.g. each hour) of each day. This information may then be used by the system to update the scheduling or and/or arrange the time slots 2.

The updated data may be useful in generating the forecasts for daily sales or tasks (required to create the schedule as described). The updated data is not necessarily available instantaneously and may take some time to enter the system, particularly where the data is taken from a different system. Preferably, the updated data is available within the repeating shift or work time frame, for example a week, so that a time period in the existing work time frame can be compared to that same time period of the previous work time frame, for example one Friday evening time period or day can be compared with the Friday evening time period or day of the week before. In an embodiment of the invention, the predicted revenue data, or predicted template is compared to the actual revenue data or actual template used and a comparison is made as detailed herein.

In an embodiment where the updated data is imported in a reasonable period of time, for instance less than a week, further operations may take place using the updated data. These operations may include and expand on the statistical modelling which created the initial schedule. In broad terms the updated data would be statistically compared against the current schedule based upon the historical data and modified schedule candidates may be created. In a first example the distribution of products and/or orders across each day (by hour) in the updated data would be compared with the historical data. The schedule candidates may appear as alternate distributions of the time slot or resources. A statistical analysis over a time period of updated data versus the current or standard template or schedule would test, or suggest, if a new standard distribution would better fit the likely future distributions. If an improvement is noticed then the underlying standard distribution could be altered. The statistical methods used could be any as known in the art.

The staff efficiency may also be adjustable based on updated data (as the updated data is now in the past it may, in some cases also be or become included with the historical data at a point). A particular staff member may be able to process a certain number of products or orders and a particular driver may make a certain number of deliveries. Initially these values may be averages or predicted values. The accurate or real values, or changes in values, for each person may be incorporated based on the updated data and this may adjust the product per hour or delivery per hour figure the scheduler uses. This may be important where staff members vary in performance from the mean so that an improved outcome is possible by scheduling them appropriately. However, in use, care should be taken to ensure that any performance differences are not due to other factors, such as time of shifts or secondary jobs. A manager may also review the expected or scheduled performance against the actual performance and, after accounting for any known differences, calculate a measure of staff performance or productivity. In embodiments this may be measured as a staff wide metric or for each member separately. Low performance could result in action being taken to increase the performance of staff or the scheduler may be adjusted to better reflect the assumed productivity.

The previous embodiment created feedback loops between the updated data and the current schedule which the system could then manage or suggest improvements to. In a further embodiment the system may create reports or other output for a controlling user or manager to review. These outputs may relate to the operation of the system or identify differences in operation between the system and the actual results. Hence they provide feedback about both the system and the operation of the location, store or staff that relates to the system.

A number of examples may be provided regarding the second system.

In a first example, if the schedules and the updated data have substantial differences then the forecasting model may need to be altered to better reflect the expected production or timings. Other possibilities such as inspecting how the store, store manager or marketing are operated could also identify a fault.

In a second example, if the staff assigned by the method varies from the actual staff used, or roles taken, on the day this may need correction. For instance the manager may not be following the schedule or rota, or the expected work or product sales on the day may not as predicted (either higher or lower) or some other operational issue may exist (absenteeism, inability to use rota, not clocking in etc.) The method may hence identify issues involved with the operation of a proposed schedule.

In a third example, if the productivity measures as expressed from the updated data are not as would be expected generally from historical trading or trading in a particular good then investigation may be need to ascertain why this is. This may identify both positive and negative features associated with the operations.

In a fourth example, if the scheduled staffing levels are compared to other performance data of the method (delivery time, bad orders, production time, monetary performance etc.) then many factors can be examined. For example the productivity values could be inaccurate, certain times of the day may have bad performances (peak rush hour) due to external circumstances or possibly the timing at which staffing changes occur off could be poor. For example staff may be sent home too early and this may mean that late night sales peaks may be understaffed. Similarly staff may be brought in too late to provide support for an increase in production. Staff may be required for a 6 pm sales pickup but may take a period of time, say 30 minutes, before they are fully productive which may affect the schedules performance metrics (though not necessarily the productivity metric).

The system may include a forecasting option which allows the user or manager to depart from the scheduled system. This allows the manager to adjust the schedule when unusual, atypical or unexpected events occur or are planned. For instance such events may include a store promotion, a local event or a weather effect. This allows the scheduling to depart from an averaged model of history and instead provide a forecast driven system. In a preferred embodiment the forecasting optimization is achieved by a per hour, per effort level modification to the system.

A store running a promotion that will up the amount of carry-out sales (and decrease the deliveries) can enter a weight, which reflects that change on a per hour basis, into the system and the optimal work slot calculated will reflect that (in this case by having more in-store staff and less drivers). Any weight changes interface with various constraints to ensure that minimum staffing levels, closing staff and auxiliary requirements remain met. The system is not limited to staff weight metrics. Many other metrics may also be included and adjusted to provide store or business specific requirements. For instance a metric for the productivity of the staff (per hour, per effort level) may be adjustable to allow an accurate forecast of staff production. This enables the manager to adjust the schedule in instances where it appears inaccurate through his knowledge of the store and/or operations.

Further the divergence from the optimal or predicted day and the manager's actual day is visible and reportable to head office or the manager's manager. In an embodiment there are limits to the amount of divergence to the scheduled day that a manager can make. For instance the manager may diverge from the schedule in hours, either over or under. The total number of rostered hours can then be compared to the scheduled approach for each day, only allowing the built roster to be saved if it falls with a percentage of optimal. This enables flexibility for the manager while maintaining the constraints of the scheduling system. The closeness of the roster to the optimal roster required may be set or adjusted by the manager's head office or superior. As described above the schedule can be derived first and then suitable staff members entered in to each time slot, so that the difficulty of optimising both workers and timetabling is reduced.

In an embodiment the invention provides monitoring of forecasts on a frequent basis—for instance hourly. This allows the monitor and update the forecasts including calculating the optimal effort requirement based on hourly sales and orders actual figures obtained from the store operations. The adjusted requirements may then be transmitted to the on-site manager. The transmission information may include the list of assumptions which have changed, a selection of candidate schedules, or an updated schedule. This allows the manager to make real time fine grained adjustments to the staff levels. The transmission may use the scheduling computer or may interface with a mobile communication system such as a SMS messaging system. So for example if the forecast sales had the 4 pm-5 pm sale forecast at 1500 units but actual store sales from 4-5 are 1100 units then a SMS message goes out with the change to staffing slots of the newly calculated optimal versus the previously planned optimal. This may reduce the staffing levels based on an assumption of a quieter day.

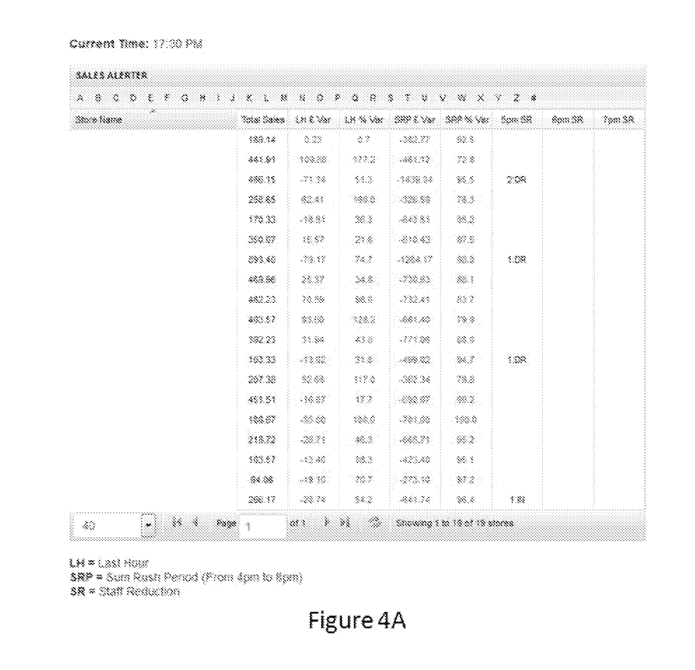

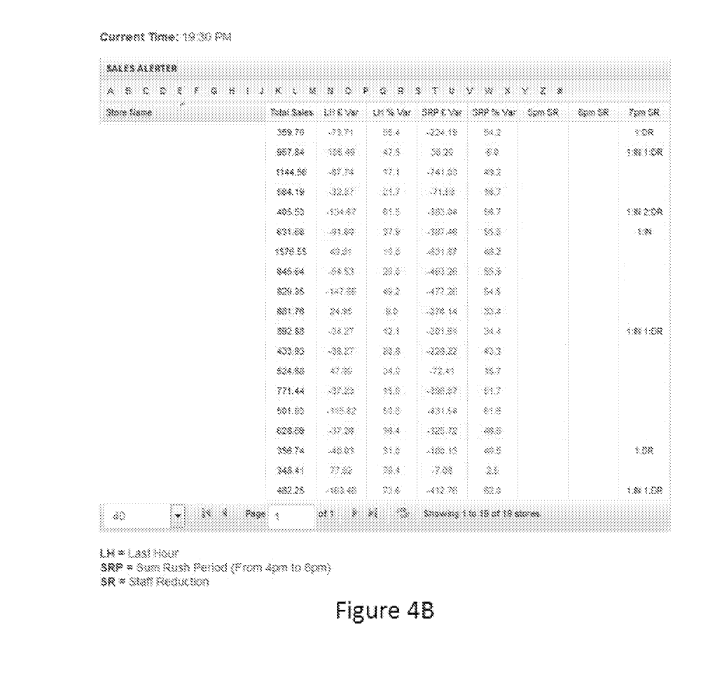

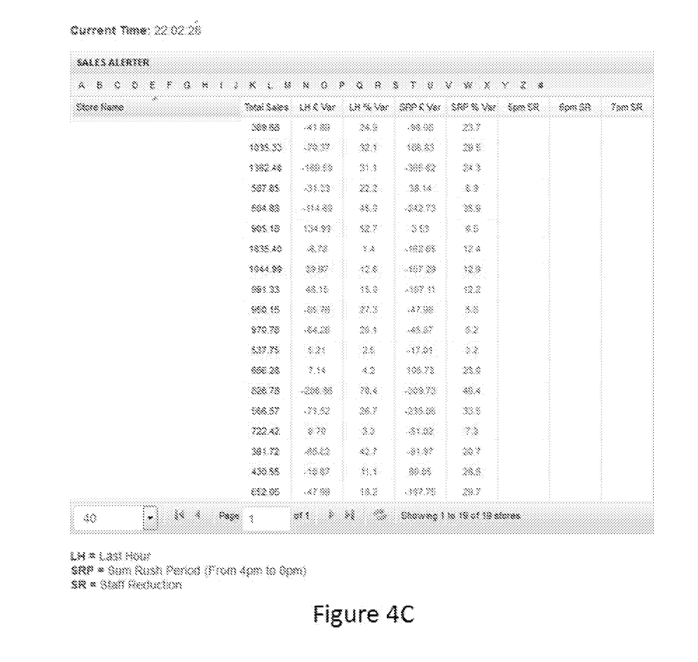

In addition to the optimal schedule slots, an optimal expected cost and cost as a percent of sales figures may be generated. These provide an alternative view alongside the roster/rota as built and the actual roster or outcome as carried out. This data, shown in FIG. 4 can be provided to the manager, area manager, regional manager and head office or others as part of control scheme to monitor and control variance from expected or forecast costs.

FIGS. 4A, 4B and 4C show a series of production units or restaurants and the changing data at different times over a four hour period from 4:00 p.m. to 8:00 p.m. FIG. 4A shows the 5:30 p.m. snapshot. The total sales show the cumulative sales over the four hour period with the period values for expected revenue shown in SRP $ Var and SRP % Var columns. These provide an overview of the four hour period, however as it has only just begun it is difficult to review the details. An important parameter is the LH variations from the expected revenue shown in the LH $ Var and LH % Var columns. The last hour columns may be fed into the statistical methods controlling the program and used to determine if a change in staffing levels is required.

For instance FIG. 4A shows that at 5:00 p.m. four drivers and one instore worker should be reduced across the production units. The use of historical data and metrics allows the method to be flexible and account for variations, the result being that some production units with poor last hours do not reduce staff any further. FIG. 4B shows a second snapshot at 7:30 p.m. in which the columns have been updated to refer to the last hour and further staff reductions have been suggested across the production units. FIG. 4C shows the final positions for the 4-hour period

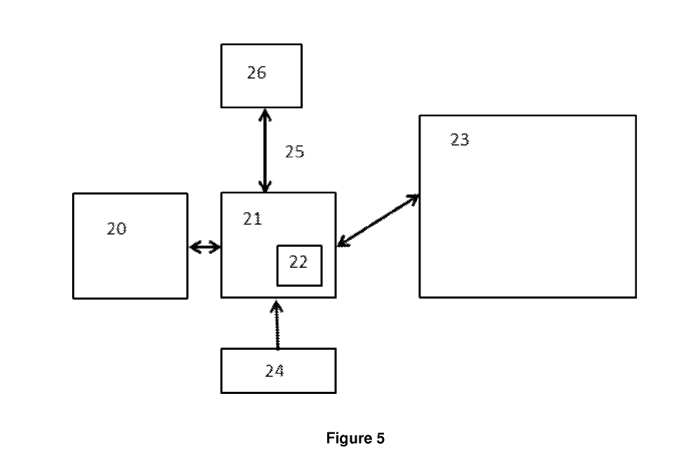

In a preferred embodiment of the present invention this is done on a computerised apparatus 14 such as, but not limited to a computer, for example a mainframe, remote server or cloud-cluster as shown in FIG. 5. Alternative forms of the present invention may be a computer program or computer readable medium to perform the method. The computerised apparatus 21 may include a microprocessor, FPGA, logic circuit or other form of processor 22. An application may be used to interface with the manager/user, other devices including display devices 23 or interface with another computerised device locally or through a network or wired/wireless communications 25. The computerised apparatus may also be referred to as a processing unit or means 21 and may be a microprocessor or an electronic device such as a PC or laptop. The processing unit may receive information from a data storage device 20 such as a removable storage disk, hard-disk, ROM, RAM or a network connection. The method of scheduling resources may be stored on a data storage device 20. The processing of the information may take place on the computing device, on an external computing device 26 or a combination of computing devices. The external computing device, or another external computing device 26 may also be used to send or receive information between the computerised apparatus 21 and a user. Preferably a display device 23, such as a screen is used to display the template to a user although the template may be printed. For instance the display device may show the template and a plurality of staff options (preferably including their skills) which may be added to the template through the use of an interface device 24 such as a mouse, touchpad, keyboard or joystick.

The foregoing description of the invention includes preferred forms thereof. Modifications may be made thereto without departing from the scope of the invention.

What is claimed is:

1. A method of scheduling resources, comprising:
forecasting a required revenue for an operation in at least one desired time slot;
reviewing historical revenue data of said operation or a similar operation;
analyzing said required revenue and said historical revenue and determining a work effort metric for said at least one desired time slot to meet said required revenue;
generating or selecting a template for said at least one desired time slot showing the desired said work effort metric; and
filling said template by allocating specific resources to said at least one desired time slot.

2. The method of scheduling resources as claimed in claim 1 wherein said work effort metric is based on a standard period of time, for example per minute, hour or day.

3. The method of scheduling resources as claimed in claim 1 wherein said work effort metric includes one or a number of resources and the skill required for that said at least one desired time slot.

4. The method of scheduling resources as claimed in claim 1 wherein said analysis includes at least a statistical analysis of said required revenue and or said historical revenue data.

5. The method of scheduling resources as claimed in claim 1 wherein said at least one desired time slot is of variable length to cover any period of time or time increments as needed.

6. The method of scheduling resources as claimed in claim 1 wherein there is a plurality of said desired time slots.

7. The method of scheduling resources as claimed in claim 1 wherein said revenue data is based on any one or more of the following by said operation: units made, units sold, delivery mechanism, and effort necessary.

8. The method of scheduling resources as claimed in claim 1 wherein said resources are human resources.

9. The method of scheduling resources as claimed in claim 1 wherein said required revenue and/or said historical revenue data is based on units per time increment.

10. The method of scheduling resources as claimed in claim 1 wherein said analysis includes units delivered per time increment.

11. The method of scheduling resources as claimed in claim 1 wherein said template is generated as part of a user interface which a user can then drag and drop said resources to fill said template.

12. The method of scheduling resources as claimed in claim 1 wherein said template includes multiple operations, or operation stations within said at least one time slot.

13. The method of scheduling resources as claimed in claim 1 wherein said method is performed at least in part on a computer, or computer based system.

14. The method of scheduling resources as claimed in claim 1 wherein said method includes the step of comparing the forecast of said required revenue or a predicted revenue data with the actual revenue data.

15. The method of scheduling resources as claimed in claim 1 wherein said method comprises the step of creating a plurality of template options or an amended template based on actual revenue data and the step selecting one of the said plurality of template options or said amended template.

16. The method of scheduling resources as claimed in claim 1 wherein said method comprises the step of adjusting the analyses to include the actual performance of at least one of said resources.

17. The method of scheduling resources as claimed in claim 1 wherein said method includes the step of calculating a performance of the system and reporting the performance of the system to a user and/or a second user.

18. The method of scheduling resources as claimed in claim 17 wherein said reporting uses a smart device or web enabled system, such as but not limited to SMS, email, a popup dialog on a website or an instant message on a smart device.

19. A system for implementing a method of scheduling temporary resources, comprising a processor configured to:
forecast a required revenue for an operation in at least one desired time slot;
review historical revenue data of said operation or a similar operation;
analyze said required revenue and said historical revenue and determining a work effort metric for said at least one desired time slot to meet said required revenue;
generate or select a template for said at least one desired time slot showing the desired said work effort metric; and
fill said template by allocating specific resources to said at least one desired time slot.

20. A non-transitory storage medium having machine-readable instructions stored thereon, that when executed by a processor cause the processor to perform the method comprising:
forecasting a required revenue for an operation in at least one desired time slot;
reviewing historical revenue data of said operation or a similar operation;
analyzing said required revenue and said historical revenue and determining a work effort metric for said at least one desired time slot to meet said required revenue;
generating or selecting a template for said at least one desired time slot showing the desired said work effort metric; and
filling said template by allocating specific resources to said at least one desired time slot.
